(19) United States
(12) Patent Application Publication
(10) Pub. No.: US 2017/0249533 A1
(43) Pub. Date: Aug. 31, 2017

(54) System and Method for Collaborative Identity Management

(71) Applicant: Edward Scott Honour, Schaumburg, IL (US)

(72) Inventor: Edward Scott Honour, Schaumburg, IL (US)

(73) Assignee: XR Identity LLC., Chicago, IL (US)

(21) Appl. No.: 15/595,698

(22) Filed: May 15, 2017

(51) Int. Cl. G06K 9/62; G06K 17/00; G06Q 30/02

(52) U.S. Cl. CPC G06K 9/6201; G06Q 30/0201; G06K 17/00; H04L 67/22

(57) ABSTRACT

A system and method used for collaborative identification and identity management that in various embodiments can actively, passively, and collaboratively identify an individual, place, or thing, by using a plurality of digital identifiers provided by participants and non-participants in the collaborative environment. The system and method provides for anonymous identification, whereas the person or object cannot be personally identified without additional information that is maintained outside the invention.

### FIELD OF INVENTION

The present invention related to the field of computer assisted identification, in particular to a system that intakes a plurality of digital identifiers and returns one or more anonymous consolidated identifiers based on data provided by collaborative participants along with data obtained through the use of the invention.

### BACKGROUND OF INVENTION

The present invention relates to the method of identifying persons or devices based on the use of digital identifiers in which the digital identifiers may be read and processed without the knowledge of the individual being identified. In addition, the digital identifiers may or may not be provided by the person or business performing the identification.

The Internet of Things (IoT) has expanded the internet to include billions of networked devices that can be accessed, identified, and controlled using computer software. As the number and capability of networked devices continues to grow, the need to identify people and devices, along with need to identify interaction between people, places, and connected devices is fundamental to creating computer controlled environments that adapt to the presence and interaction of persons, places, and things.

Many IoT devices perform detection activities and transmit information about the environment back to the owner of the device while operating automatically without human interaction. An input device that operates without human interaction is called an “active” device since it is actively performing a task. Most active input devices operate on a time schedule such that they scan the environment on a repeating interval. Input devices that require human interaction such as cash registers and bar code scanners are considered “passive” devices since they are not used unless they being controlled by a person. The use of active identification of individuals allows system owners such as retail stores to provide targeted information to customers, and/or change the customer's environment by automatically controlling other passive and active IoT devices.

The field of identity management relates to the technologies required to identify an individual in order to provide access to systems or devices, and deliver content based on that person's identity. Traditionally within computer systems, identities are managed internally using a unique key value such as a personnel ID, or device id, and externally using a secondary identifier that is recognizable and memorable to a person such as a username, email, or phone number. Since secondary identifiers are difficult to manage, one facet of identity management bridges internal identification of individuals with identifiers that are usable and understandable by individuals.

Within traditional identity management systems, and prior to the present invention, identity management systems were presented with a single identifier such as a user name secured with a password, and a single unique identifier representing user would be returned. This traditional approach is not suitable for active IoT uses, because a single input device such as a digital scanner can process hundreds of identifiers simultaneously, and individuals may possess several readable identifiers at the same time.

When active input devices read digital identifiers, the identifiers may have been provided by the operator or owner of the device, or they may have been provided by others who are also using compatible technologies for their digital identifiers. In the case where several businesses are using digital identifiers that are scanned and processed using the same technologies, such as ultra high frequency radio frequency identifiers (UHF RFID), they can benefit greatly by operating in a collaborative environment.

Collaborative digital identification supports the process of simultaneously identifying multiple persons or things using one or more digital identifiers that may have been originally provided by different sources. These identifiers may be read passively or actively depending on the type of device used to read and send the identifiers.

Examples of passive identifiers that may be used within the present invention, include printed barcodes that must be scanned by a bar code scanner, a phone number that must be entered into a computer or cash register, or an email address used to sign into a computer system. Examples of active identifiers may include UHF, HF, and LF radio frequency identification (RFID) tags that return a unique identifier when scanned, or Bluetooth, WiFi, or mobile phone identifiers (IMEI) that are always transmitting from a person's devices.

Currently, most consumer identification and loyalty systems use a passive identification process where a badge or loyalty card, with a bar code, is scanned using a bar code scanner at the cash register to identify the individual. As a backup to the loyalty card, the person's phone number or email address can usually be used as a passive backup identifier.

In order to provide active identification, system owners can provide badges, loyalty cards, or other tags, that contain an identifier that supports active identification such as RFID. The use of active identifiers allows automatic digital interrogators to read the digital identifier from the tag without the knowledge of the card holder. This allows the operator of the system to control the environment in a way specific to the current store visitors, generate visitor logs, issue loyalty points, and provide customized interactive content for visitors based on the visitor's history and preferences without human interaction.

Collaborative identity management solves several drawbacks to active identity management systems, including lost cards, failure to use loyalty program at checkout, and individuals who do not carry all of their loyalty cards with them after they are issued. Most participants in loyalty programs usually participate in several programs. For this reason they rarely have all their loyalty cards in their possession which makes active identification difficult.

Collaborative identity management allows system operators (stores, etc.) to use active digital identifiers that were provided by the system operator along with identifiers provided by other participants in the collaborative system. This allows a participant (store) to be able to actively identify a loyalty card hold by scanning any loyalty card or digital identifier provided by any of the participants in the identity management collaboration. By using collaborative identity management, participants can greatly improve identification and engagement of loyalty card and other identity based applications.

Prior to the present invention, there is no system and method to actively, simultaneously, and collaboratively, identify persons, places, and things using active digital identifiers where the identity is in possession of at least one digital identifier, even if the identifier was not issued by the system operator performing the identification.

Therefore, it would be advantageous to provide a system and method for building, maintaining, and employing an active and collaborative identification mechanism supporting a wide range of digital identifiers.

### SUMMARY OF INVENTION

In view of the deficiencies described above, it is an objective of the present invention to provide a novel system and method to enable and manage the active and collaborative identification of individuals and devices using a plurality of active and passive digital identifiers which may be read without the knowledge of the individuals or devices being identified.

In accordance with the objectives of the current invention, is a system and method for an identity management engine that simultaneously intakes digital identifiers and outputs a consolidated list of one or more unique identifiers that can be used to identify individuals or devices across a collaborative environment. Such an identity management engine shall manage the identities of persons, places, and things.

Embodied in the invention is a method for automatically determining that identities within the system represent the same physical entity, when the same physical entity was added to the system by different system operators. This allows digital identifiers used to identify any of the related identities to be used to identify all of the related identities.

Also embodied in the invention is a method to detect and assign additional digital identifiers to an identity and its related identities after they have been detected by the system multiple times. The method involves a scoring mechanism that provides an measurement index that must achieve a scoring threshold to be linked to an identity. The scoring mechanism involves matching unknown identifiers with data sets that include the known identities that were identified by the system. This allows the invention to operate effectively as the digital identifiers in possession of individuals changes over time.

### BRIEF DESCRIPTION OF THE DRAWINGS

FIG. 1 is a pictorial representation of a detection scenario in which the present invention may be implemented is depicted in accordance with a preferred embodiment of the present invention;

FIG. 2 is a diagram illustrating the relationship between active and passive digital identifiers and unique identities in accordance with a preferred embodiment of the present invention.

FIG. 3 is a diagram illustrating the intake, processing, and output of digital identifiers in accordance with a preferred embodiment of the present invention.

FIG. 4 is a diagram representing the steps in a method for collaborative identity management in accordance with an exemplary embodiment of the present invention.

FIG. 5 is a flow diagram representing the process flow for associating unknown active digital identifiers with identities within an active collaborative identity management solution in accordance with a preferred embodiment of the present invention.

FIG. 6 is a flow diagram representing the method for scoring the confidence that an unknown digital identifier is associated with a known identity within an active collaborative identity management solution in accordance with a preferred embodiment of the present invention.

FIG. 7 is a flow diagram representing the steps in a method for creating a new identities within a collaborative identity management solution in accordance with a preferred embodiment of the present invention.

FIG. 8 is a diagram illustrating the relationship between identities stored in a database maintained by a user of the invention and identities maintained in the invention in accordance with a preferred embodiment of the present invention.

### DETAILED DESCRIPTION OF THE DRAWINGS

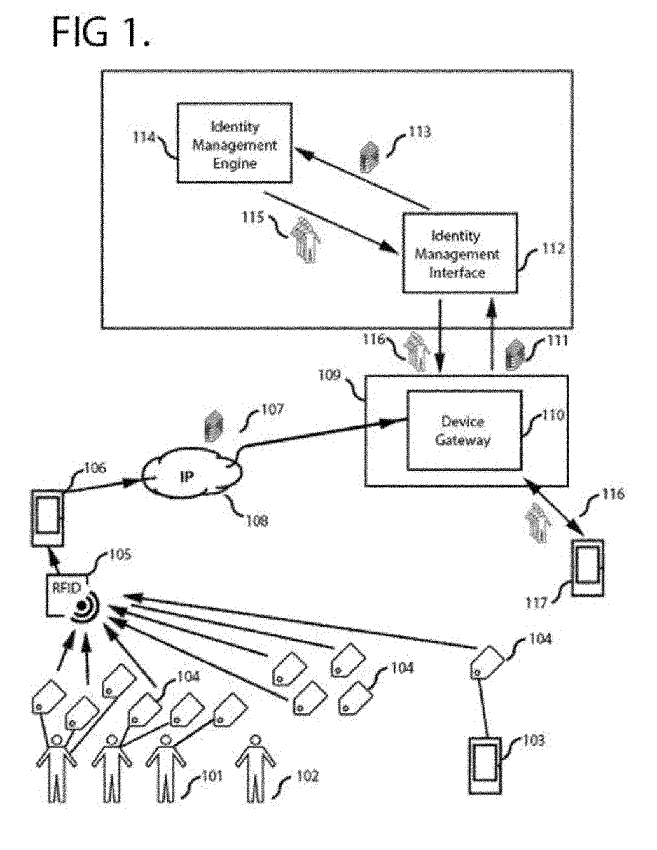

With reference now to the figures and in particular with reference to FIG. 1, a pictorial representation of a detection scenario in which the present invention may be implemented in accordance with a preferred embodiment of the present invention. People 101 and 102, and devices 103 may or may not possess digital identifiers, 104 that are detected and read by a digital interrogator 105. The digital identifiers 104 are processed and summarized by an interface gateway processing unit 106 that formats digital identifier information into a package 107 to be transmitted via the internet or a closed network 108 to a computer system operated by the owner of the system 109 or an entity who is operating the computer system on behalf of several collaborating entities. The computer system 109 uses a software interface 110 to verify the validity of the device and its data and ensure the digital identifiers were transmitted from a trusted source. The software interface 110 formats and encrypts the data into a secure package 111 for further use in the system. The package 111 is sent to the identity management interface 112 where the digital identifiers are sorted 113 and transmitted to the identity management engine 114. The identity management engine 114 identifies known identities and creates a package of known identities 115 that are returned to the identity management interface 112. The Identity management interface compares the identities returned by the identity management engine with the list of identities maintained by the identity management interface to determine if the list of identities has changed. If the list has changed, the identity management interface 112 executes a software routine to send data 116 to the system owner's computer system 109. The content of the data 116 sent by the executed software routine may be determined by the system owner based on the changes to identities determined by the identity management interface 112. In the case where devices 117 are controlled by the system or data sent to other locations, the data 116 can be used by the executed software routine to control the actions of the device 117.

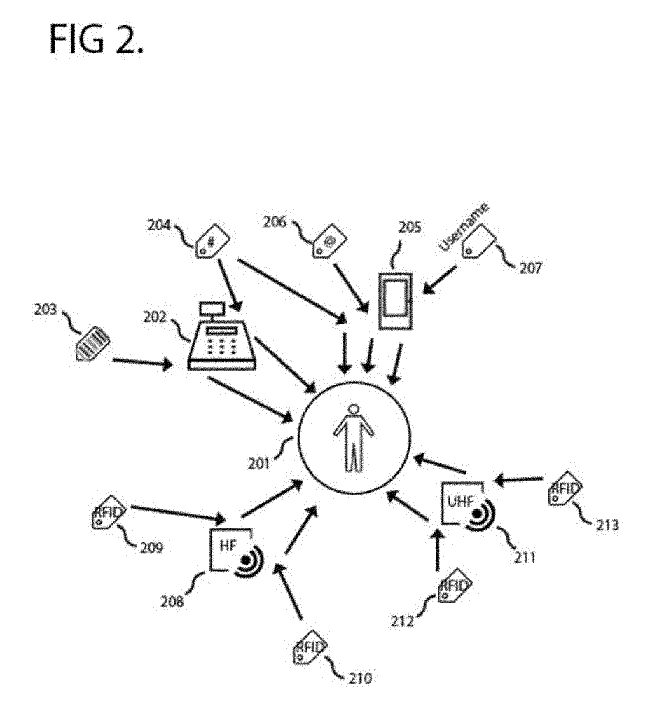

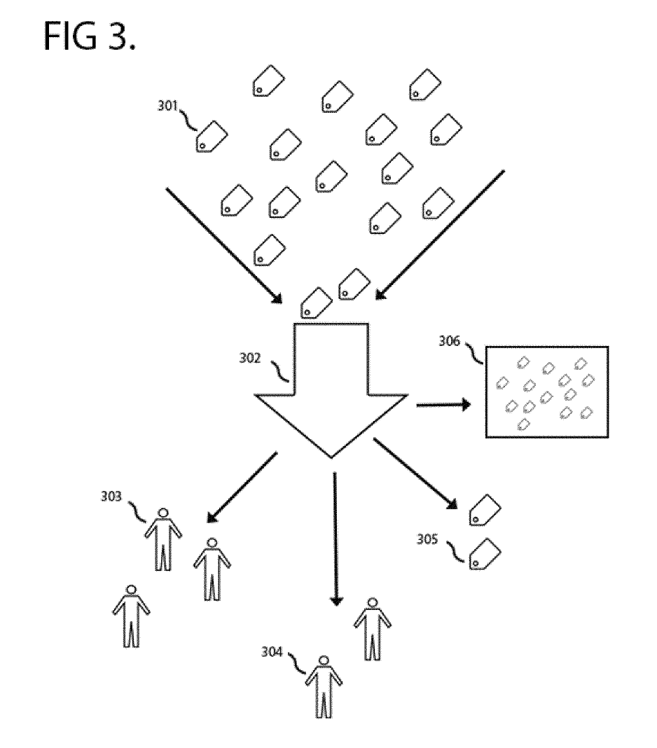

Continuing now with FIG. 2, a diagram illustrating the relationship between active and passive digital identifiers and unique identities in accordance with a preferred embodiment of the present invention. An identity 201, which may be a person, place, or thing depending on the implementation of the invention may be identified by digital identifiers which may be active, meaning they are processed automatically without human intervention or passive, meaning human interaction is required. A passive device, such as a cash register 202 or a computer 205 intakes digital identifiers such as bar codes 203, phone numbers 204, email addresses 206, or user names 207. Each of these identifiers may be used to uniquely identify an identity to the user of the system. Passive identifiers may require information identifying the owner of the intake device to be appended to the identifier to cause the identifier to be unique within the collaborative system. An active input device such as a high frequency RFID scanner 208 or an ultra high frequency RFID scanner 211 automatically scans for the existence of compatible RF identifiers. An HF RFID tag 209 may be simultaneously processed with other compatible HF RFID tags 210 that can be used to identify the identity 201. In certain cases the identity 201 may require more than one digital identifier to perform the identification and in other cases the identification can be performed with a single identifier. Different type of active scanning devices have different properties and capabilities. The UHF RFID scanner 211 can process digital identifiers, 212 and 213 at distances up to 30 feet, where the HF RFID scanner, 208 requires digital identifiers 209 and 210 to be within 3 feet in order to be detected. The intake and processing of digital identifiers create an output of digital identities which are processed within the system and method using a preferred embodiment of the present invention as shown in FIG. 3.

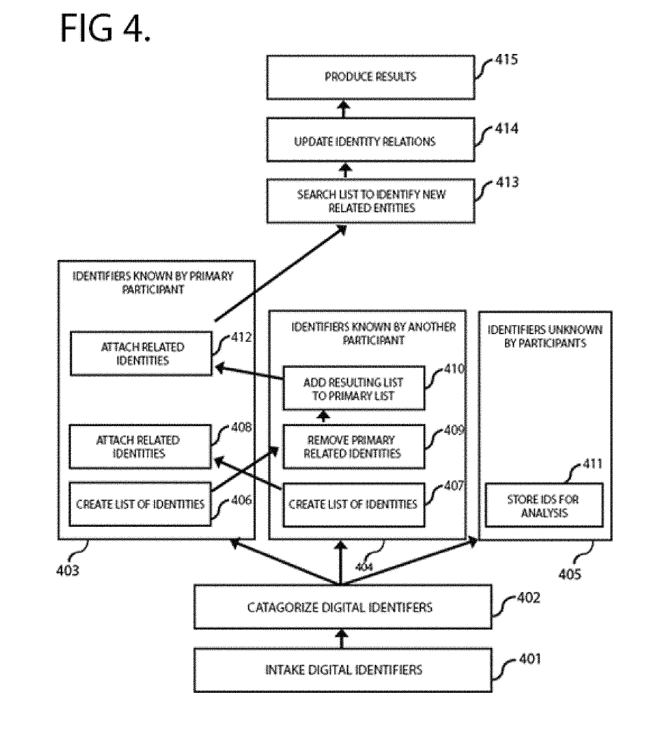

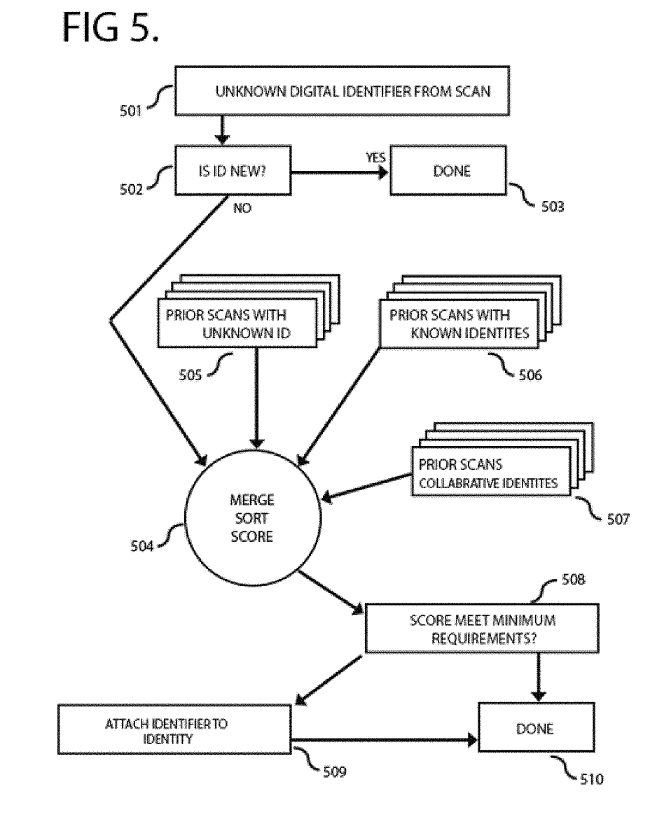

Continuing now with FIG. 3, a diagram illustrating the intake and processing or digital identifiers to produce an output of identities in accordance with a preferred embodiment of the present invention. A plurality of digital identifiers 301 are read by an active digital scanner as shown in FIGS. 2, 208 and 211 and passed to the processing routine 302 that is used to produce the desired output of the system. A preferred embodiment of 302 is further defined in FIG. 4. A list of identities 303 is produced that includes identities directly related to the operator of the system. The identities contained in 303 may have been initially created by the operator of the system, or may have been created by a collaborating system operator on behalf of the operator. A further list of identities 304 is generated that includes identities that were created and are managed by a collaborating system operator but are not know as identities to the operator of the system. These identities 304 make be used by the system operator to determine the total number of identities at a location without knowing who or what the identities are. A list of unmatched identifiers 305 is created along with a data set 306 that are used to with other data sets to further match unknown identifiers to known identities. The unknown identifiers 305 may be matched with known identities immediately, or may be matched at a later time when additional data sets, like 306, are available for processing. Unknown identifiers 305 that are created by other iterations of the process may use 306 in its matching process. An embodiment of a process using 305 and 306 is detailed in FIG. 5.

Continuing now with FIG. 4, a diagram representing the steps in a method for collaborative identity management, show in FIG. 3, item 302 in accordance with an exemplary embodiment of the present invention. Within the identity management engine FIG. 1, item 114, which is processed in FIG. 3, item 302, the process in FIG. 4 begins with the intake of digital identifiers 401 which begins at the bottom of the drawing and moves upward. The digital identifiers are categorized into three categories 402, identifiers known by the participant 403, identifiers known by other participants in the collaboration 404, and identifiers that are readable by the system but are not known 405. Beginning at 406, the initial list of identifiers known by the participant is processed to create a list of identities that are identified from the digital identifiers. The initial list of identifiers known to other participants 404 is processed in 407 to create a list of identities derived from the list. Identities in 407 are then matched with identities in 406 to identify identities that represent the same person and create a list of related identities 408. The identities that were related by 408 are removed from the list 409 and then the remaining list is added 410 to the final list of identities. Any identifiers that are not known to the system are stored 411 for later analysis. In step 412 known related identities that have not been identified in other steps are added to the primary list so that in step 413 any other relationships between identities can be identified. Once new identity relationships are identified, the new relationships are updated in step 414 and the final results are generated in 415.

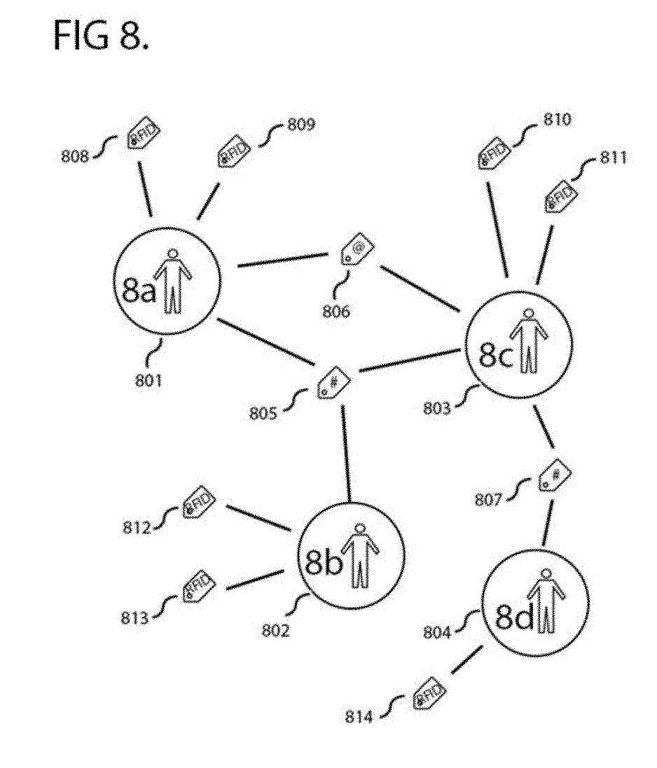

Continuing now with FIG. 5, a flow diagram representing the process flow for associating unknown active digital identifiers, shown in FIG. 3, item 305, with known identities within an active collaborative identity management solution in accordance with a preferred embodiment of the present invention. The process is performed for each unknown identifier contained in 305 beginning at 501. The process first determines 502 if the identifier is new to the collaborative system. If the identifier is new, there is not enough data to continue processing the identifier and the process is completed 503. If the identifier has been found in other data sets 306, prior scans containing the unknown identifier 505, along with all data sets from prior scans containing all of the 303 known identities 506 that where identified in the scan, and 507, all data sets containing identities from 304 are passed to a scoring routine 504 to determine a relationship score for each of the known identities from 506 and 507. The resulting scores for known identities are processed 508 to determine if any identities meet the minimum scoring requirement to have the identifier attached to the identity 509 and complete the process 510. It is possible for no identities to meet the minimum score requirements, in which case the identifier remains unknown until it is detected again within another iteration of the system. Within a preferred embodiment of the invention, it is possible for an identifier to meet the minimum score requirements for both identities known by the operators of the current iteration of the system and also by collaborative system operators. In the case of multiple minimum scores determined in the same iteration of the system, the identifier is attached to the identity owned by the operator the process. FIG. 8 show how this determination also allows collaborative system operators to use this identifier in future iteration of the identity identification process.

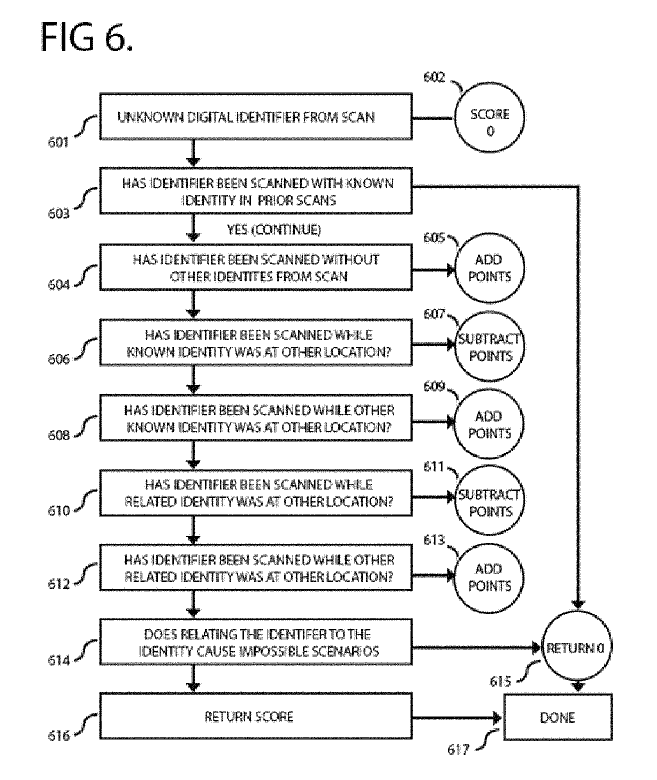

Continuing now with FIG. 6, a flow diagram representing the method for scoring the confidence that an unknown digital identifier is associated with a known identity within an active collaborative identity management solution in accordance with a preferred embodiment of the present invention. FIG. 6 represents a preferred embodiment of the process internal to 504. The process is FIG. 6 is performed to score each unknown identifier 305 with each know identity owned by the operator of the current iteration of the process 303 and each known identity owned by collaborating system operators 304. The scoring process begins 601 with a score of 0 as shown in 602. If the identifier has been included in other scans where the known identity has been identified the scoring can continue with step 604, otherwise the score of 0 is returned 615 and the process completed 617. In step 604 it is determined if the identifier has been included in data sets that do not include the other known identities from the current scan. If it is the case that the identity currently processed has been identified in previous scans 603 but the other known identities have not 604 the score is increased 605 based on the number of times this situation has occurred. In step 606 it is determined if the identity has been identified to be at a location at a time where the unknown identifier was scanned at a different location. In this scenario the score decreases 607 because the identifier and the identity the system is determining a relationship with were detected at different locations at the system time. Within various embodiments of the present invention, the distance between the locations along with that wider time range can be used to increase or reduce the number of points subtracted in 607. In step 608 it is determined whether other known identities from the process where determined to be at other locations at the time the identifier was detected. When this scenario is detected, points are added 609 to the score. In various embodiments of the present invention the number of points maybe increased or decreased based on the priority other known identities are given in the scoring process. The process continues with step 610 where it is determined if related identities, which are separate identities owned by a collaborating system owner that represents the same physical person, place, or thing, where identified while the unknown identifier was at a different. In the case of this occurrence, points are subtracted from the score 611 in the same manner as 607. The process then continues in step 612 where points are added 613 in the same manner as 609 if the related entities where identified while other known identities are at other locations. Finally, step 614 assumes the unknown identifier is related to the identity being scored to determine whether relating the identifier to the identity creates and impossible scenario, such as the identity being at multiple locations at the same time, or traveling impossible distances in a short time. If 614 determine that impossible scenarios occur, the score of 0 is returned in step 615, otherwise the score is returned in step 616 and the process completed in step

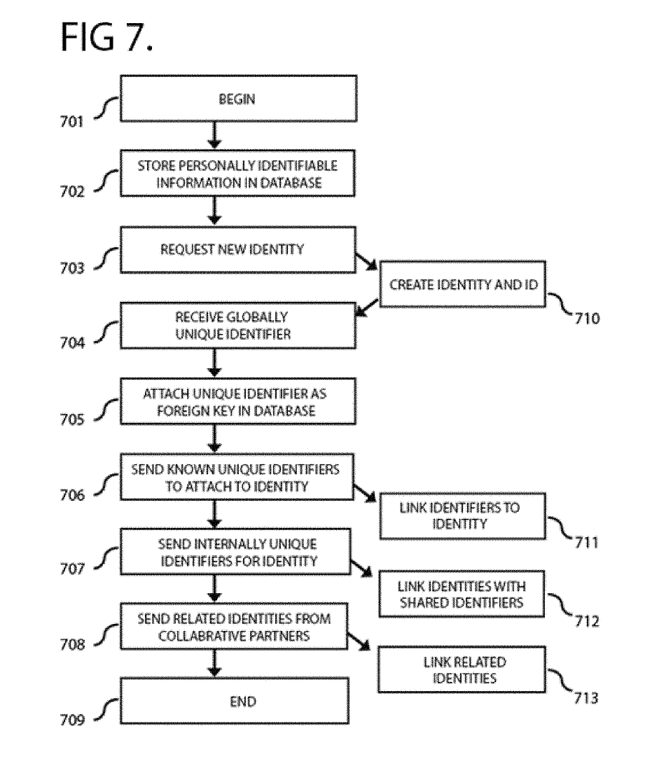

Continuing now with FIG. 7, a flow diagram representing the steps in a method for creating a new identities within a collaborative identity management solution in accordance with a preferred embodiment of the present invention. This process may occur in scenarios such as having customers sign up for a new loyalty program or a security badge being issued to a building occupant. The process begins 701 and the system operator stores information that is personally identifiable or proprietary to the system operators business in a database controlled and secured by the system operator 702. The system operator then request a new identity 703 from the invention. The invention creates an identity within the system and returns a identifier that is unique across all identities in the collaborative environment 710. This unique identifier is attached to the record within the owners system as a foreign key 705. Since the identifier is unique and will not change, the system owner has the option of using the identifier as the primary key within the owner's system. Next, in step 706 the system operator sends identifiers that it knows to be unique, such as active RFID tags to the invention. The invention links these identifiers to the identifiers to the identity 711. In step 707 the system operator sends identifiers that may be unique internally, such as email address and phone numbers, that may not be unique across a collaborative system. In 712, the invention links the identifiers to the identity and includes system operator information in the key values allowing it to be unique and searchable within the system. The process ends in step 709.

Continuing now with FIG. 8, a diagram illustrating the relationship between identities stored in a database maintained by a user of the invention and identities maintained in the invention in accordance with a preferred embodiment of the present invention. Identities 8a, 8b, 8c, and 8d which represent the same physical person. Each of the identities was added to the system by a collaborative participant. Passive digital identifiers such as a phone number 805 make it possible to identify the identities as same physical identity. In the current representation, 805 links identities 8a, 8b, and 8c and an email address 806 makes it possible to link identities 8a and 8c. A secondary phone number 807 makes it possible to link identities 8c and 8d. A detection scenario where the system operator 801 creates and manages identity 8a can use the active identifiers 808 and 809 to identify identity 8a with the use of the collaborative features of the invention. In this scenario, operator 801 reading digital identifiers 808 and 809 will return identity 8a as the primary identity with identities 8b, 8c, and 8d as related identities. If operator 801 read digital identifiers 810 and 811 which are created and managed by operator 803 in order to identify identity 8c as its primary identity the relationship created by passive identifiers 806 and 805 allows operator 801 to identify identity 8a. Within a preferred embodiment of the present invention the primary identity value and its related identities are determined by the operator of the scenario. When the scenario is performed by operator 801 identity 8a is returned as the primary identity regardless of the digital identifiers used. As such, when ready operator 802 performs the scenario identity 8b is returned as the primary identity. When operator 803 performs the scenario, identity 8c is returned as the primary identity, and when operator 804 performs the scenario, identity 8d is returned as the primary identity.

1. A system and method for identifying an identity or group of identities using a plurality of digital identifiers.

2. A system and method for identifying an identity or group of identities wherein the identities may represent a person, place, or thing.

3. A system and method identifying an identity or group of identities wherein the identities cannot be personally identified by only using information stored within the system.

4. A system and method for identifying an identity or group of identities as in claims 1 and 2 wherein the digital identifiers used to perform the identification are detected and read automatically without human interaction or manually involving human interaction.

5. A system and method for identifying an identity or group of identities as in claims 1, 2, and 4 wherein multiple digital identifiers are processed simultaneously.

6. A system and method for identifying an identity or group of identities as in claims 1, 2, 4, and 5 wherein multiple system users participate in a collaborative environment.

7. A system and method for identifying an identity or group of identities as in claim 6 wherein one or more unique identifiers are output that identify the same physical identity.

8. A system and method for identifying an identity or group of identities as in claims 6 and 7 wherein the unique identifiers output for each physical identity contains separate unique identifiers for each participant in the collaborative environment.

9. A system and method for identifying an identity or group of identities as in claims 1 and 8 wherein the primary unique identifier output by the method is the unique identifier generated when the participant first registers the identity with the system.

10. A system and method for identifying an identity or group of identities as in claims 1 and 9 wherein the unique identifiers representing the same physical identity are related to each other using common digital identifiers.

11. A system and method for identifying an identity or group of identities as in claims 1, 9, and 10 wherein digital identifiers used to relate identities identifying the same physical identity are detected automatically.

12. A system and method of identifying an identity or group of identities as in claims 1 and 11 wherein a scoring algorithm is used to determine if enough evidence exists to relate a digital identity to a unique identifier.

13. A system and method of identifying an identity or group of identities as in claims 1, 11, and 12 wherein prior datasets are used to score the evidence that a digital identifier is related to an identity.

14. A system and method of identifying an identity or group of identities as in claims 1, 10, 11, 12, and 13 wherein one or more of the scoring rules apply:
a. When an unknown digital identifier is detected for the first time it cannot be scored.
b. The score increases when a known identity is identified with the unknown identifier multiple times.
c. The score increases when a known identity is identified with the unknown identifier and other known identities are not identified in the same data sets.
d. The score decreases when the unknown digital identifier is detected and the known identity is not identified in the same data set.
e. The score returns 0 when the unknown digital identifier is detected at the same time the known identity is detected at another location that is not in close proximity.
